(19) United States
(12) Patent Application Publication
(10) Pub. No.: US 2009/0262312 A1
(43) Pub. Date: Oct. 22, 2009

(54) PROJECTION SYSTEM AND OPTICAL SHUTTER

(75) Inventors: YU-LUN HO, Tu-Cheng (TW); I-PEN CHIEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/174,638

(22) Filed: Jul. 17, 2008

(30) Foreign Application Priority Data
Apr. 17, 2008 (CN) 200810301176.5

(51) Int. Cl. G03B 21/14; G02B 26/00

(52) U.S. Cl. 353/97; 359/291

(57) ABSTRACT

An exemplary projection system includes a light source, a color wheel, an optical channel, a lens set, an image generator, and a projection lens all located along an optical pathway of the projection system. The projection system further includes an optical shutter. The optical shutter includes a shutter element and a motor for rotating the shutter element. The shutter element includes a transparent board and a light-shielding film formed on a surface of the transparent board. The light-shielding film has a notch for light to pass through. The light-shielding film is very light in weight relative to the transparent board, thus maintaining a rotational balance of the shutter element.

### FIELD OF THE INVENTION

Embodiments of the present disclosure relate to projection systems, and more particularly to a projection system and an optical shutter thereof.

### DESCRIPTION OF RELATED ART

To improve the contrast of images projected by projection systems, a projection system usually has an optical shutter disposed between an image generator and a projection lens of the projection system. The optical shutter can change the optical fluxes flowing through the image generator, thereby increasing a contrast of a projected image.

Referring to FIGS. 4 and 5, a conventional optical shutter 1 includes a shutter element 3, a motor 2 engaged with the shutter element 3, and an electrical wire 4 engaged with the motor 2 used for controlling a rotation of the motor 2. The shutter element 3 is a circular plate with an opening 3a to permit light to pass therethrough. By rotating the motor 2 together with the shutter element 3, light fluxes pass through the shutter element 3 via the opening 3a. However, because the opening 3a of the shutter element 3 is usually dissymmetric, adjusting the rotating balance of the shutter element 3 is very difficult.

What is needed, therefore, is an optical shutter for a projection system which can be more easily balanced.

### SUMMARY

In accordance with one present embodiment, an optical shutter comprises: a shutter element comprising a transparent board and a light-shielding film formed on a surface of the transparent board, the light-shielding film having a notch; and a motor for rotating the shutter element.

Other aspects and advantages of the present disclosure will become more apparent from the following description taken in conjunction with the accompanying drawings.

### BRIEF DESCRIPTION OF THE DRAWINGS

Many aspects of the present projection system and optical shutter can be better understood with reference to the following drawings. The components in the drawings are not necessarily to scale, the emphasis instead being placed upon clearly illustrating the principles of the present projection system and optical shutter.

FIG. 1 is a schematic view of one embodiment of a projection system of the present disclosure.

FIG. 2 is a side view of one embodiment of an optical shutter of the projection system of FIG. 1.

FIG. 3 is a schematic view of one embodiment of a shutter element of the optical shutter of FIG. 2.

FIG. 4 is a side view of a conventional optical shutter.

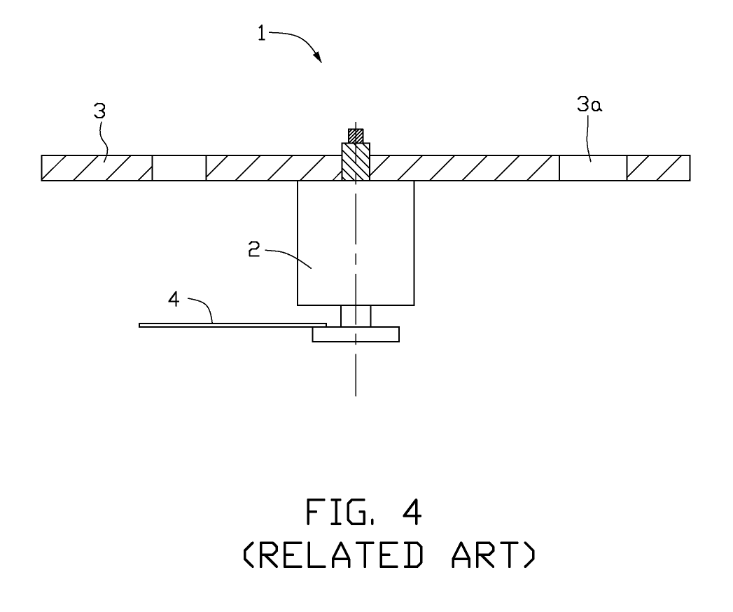

FIG. 5 is a schematic view of a shutter element of the optical shutter of FIG. 4.

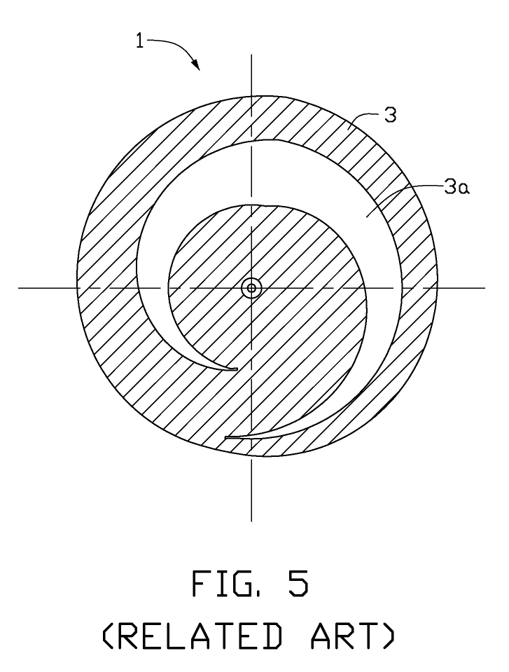

### DETAILED DESCRIPTION OF CERTAIN INVENTIVE EMBODIMENTS

Embodiments of the present disclosure will now be described in detail below, with reference to the drawings.

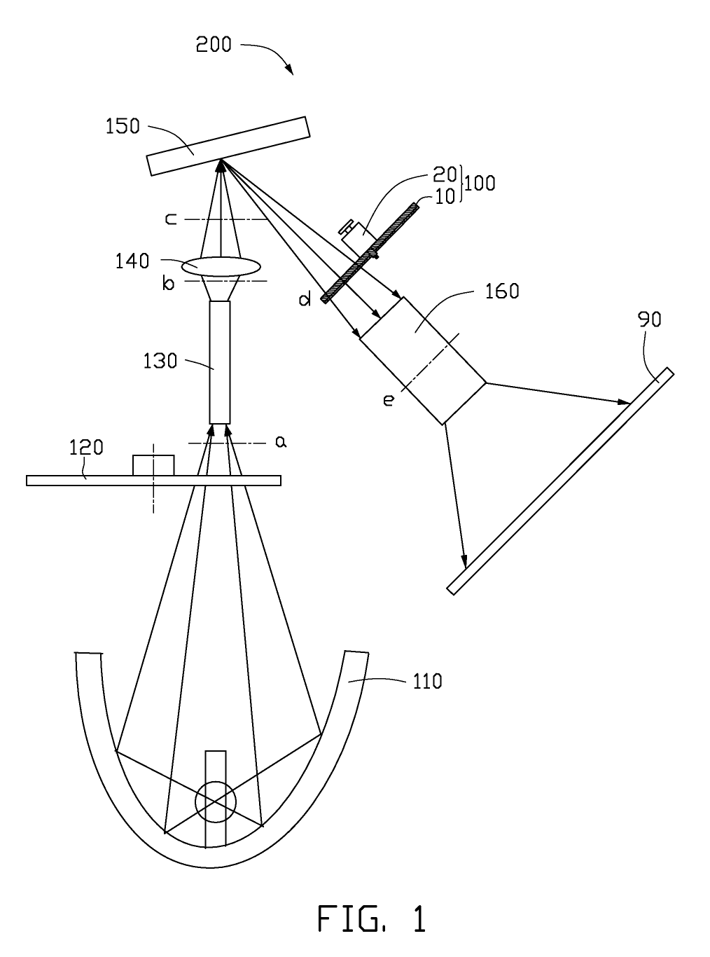

Referring to FIG. 1, a projection system 200 according to one embodiment of the present disclosure includes a light source 110, a color wheel 120, an optical channel 130, a lens set 140, an image generator 150, and a projection lens 160. The light source 110 generates a beam of light. The beam of light passes through the color wheel 120, the optical channel 130, and the lens set 140, thereby projecting onto the image generator 150. The beam is reflected from the image generator 150 to the lenses of the projection lens 160. Accordingly, the light is magnified by the lenses and projected onto a screen 90 to form an image. In one embodiment, the image generator 150 can be a digital micro-mirror device (DMD) with a plurality of micro-mirrors. The projection lens 160 has a plurality of lenses.

In one embodiment, the projection system 200 further includes an optical shutter 100 disposed between (indicated by “d” in FIG. 1) the image generator 150 and the projection lens 160. As shown in FIG. 1, the optical shutter 100 of the projection system 200 can also be disposed at any position along an optical pathway of the beam of light. For example, the optical shutter 100 can be disposed inside the projection lens 160 (indicated by “e” in FIG. 1). In other examples, the optical shutter 100 can be disposed at a position after the light passes through the color wheel 120 (indicated by “a” in FIG. 1), or after the light passes through the optical channel 130 (indicated by “b” in FIG. 1), or before the reflection of the light by the image generator 150 (indicated by “c” in FIG. 1). Such positions mentioned above are acceptable as long as the optical shutter 100 can change light fluxes of a shutter element 10, and increase the contrast of the image.

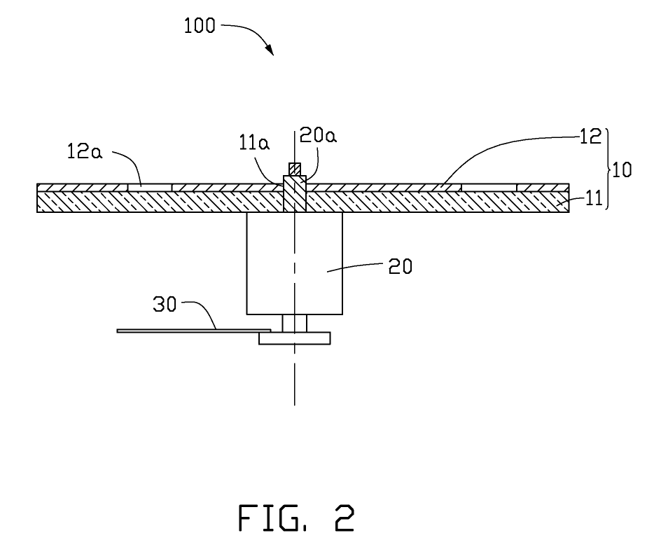

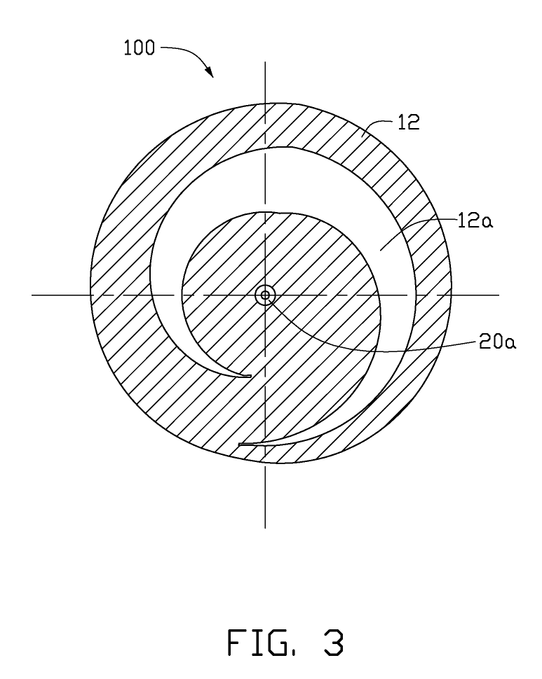

Referring to FIGS. 2 and 3, the optical shutter 100 includes the shutter element 10, a motor 20 engaged with the shutter element 10, and an electrical wire 30 engaged with the motor 20. The motor 20 is configured for rotating the shutter element 10. The electrical wire 30 is configured for controlling the rotation of the motor 20.

The shutter element 10 has a center hole 11a. The motor 20 has a rotating shaft 20a engaged in the center hole 11a for rotating the shutter element 10. The shutter element 10 includes a transparent board 11 and a light-shielding film 12 mounted on a surface of the transparent board 11.

In one embodiment, the transparent board 11 is made of a transparent material, such as glass or plastic, for example. In one particular embodiment, the transparent board 11 is a circular plastic board.

In one embodiment, the light-shielding film 12 is made of an opaque material and has a notch 12a. As shown in FIG. 3, the notch 12a is in a spiral configuration, but is not limited to this configuration. The configuration or shape of the notch 12a can be modified according to a light-shielding efficiency of the projection system 200. The light-shielding film 12 can be formed on the transparent board 11 by coating or printing, or other similar methods.

In order to further improve a rotation balance of the shutter element 10, the shutter element 10 includes a transparent film covering the notch 12a of the light-shielding film 12. The transparent film can be formed on the transparent board 11 by coating or printing, or other similar methods.

In one embodiment, the light-shielding film 12 of the shutter element 10 is very light in weight, so the notch 12a of the light-shielding film 12 should have no appreciable affect on the rotational balance of the shutter element 10. Furthermore, by using a transparent film in the notch 12a, the shutter element 10 can remain balanced, even with an asymmetrical notch defined therein, during a rotation of the shutter element 10.

While certain embodiments have been described and exemplified above, various other embodiments will be apparent to those of ordinary skill in the art from the foregoing disclosure. The present disclosure is not limited to the particular embodiments described and exemplified but is capable of considerable variation and modification without departure from the scope of the appended claims.

What is claimed is:

1. An optical shutter comprising:
a shutter element comprising a transparent board and a light-shielding film formed on a surface of the transparent board, the light-shielding film having a notch; and
a motor for rotating the shutter element.

2. The optical shutter of claim 1, wherein the transparent board is made of material selected from the group consisting of glass and plastic.

3. The optical shutter of claim 1, wherein the light-shielding film is one of a coated light-shielding film and a printed light-shielding film.

4. The optical shutter of claim 1, wherein the shutter element further includes a transparent film filled into the notch of the light-shielding film.

5. The optical shutter of claim 4, wherein the transparent film is formed on the transparent board, and is one of a coated transparent film and a printed transparent film.

6. A projection system comprising:
a light source, a color wheel, an optical channel, a lens set, an image generator, and a projection lens all located along an optical pathway of the projection system,
wherein the projection system further comprises an optical shutter, the optical shutter comprising a shutter element and a motor for rotating the shutter element, wherein the shutter element comprises a transparent board and a light-shielding film formed on a surface of the transparent board, the light-shielding film having a notch.

7. The projection system of claim 6, wherein the transparent board is made of material selected from the group consisting of glass and plastic.

8. The projection system of claim 6, wherein the light-shielding film is one of a coated light-shielding film and a printed light-shielding film.

9. The projection system of claim 6, wherein the shutter element further includes a transparent film filled in the notch of the light-shielding film.

10. The projection system of claim 9, wherein the transparent film is formed on the transparent board, and is one of a coated transparent film and a printed transparent film.

11. The projection system of claim 6, wherein the optical shutter is between the image generator and the projection lens.

12. The projection system of claim 6, wherein the optical shutter is inside the projection lens.

13. The projection system of claim 6, wherein the optical shutter is between the image generator and the lens set.

14. The projection system of claim 6, wherein the optical shutter is between the lens set and the optical channel.

15. The projection system of claim 6, wherein the optical shutter is between the optical channel and the color wheel.
